(19) United States
(12) Patent Application Publication
(10) Pub. No.: US 2008/0084908 A1
(43) Pub. Date: Apr. 10, 2008

(54) Insert for Use in Securing Refractory Members to Heat-Absorptive Elements

(75) Inventor: Thomas E. Klein, North Huntingdon, PA (US)

Correspondence Address: THE WEBB LAW FIRM, P.C., 700 KOPPERS BUILDING, 436 SEVENTH AVENUE, PITTSBURGH, PA, 15219, US

(73) Assignee: BLOOM ENGINEERING COMPANY, INC., Pittsburgh, PA (US)

(21) Appl. No.: 11/870,153

(22) Filed: Oct. 10, 2007

Related U.S. Application Data
(60) Provisional application No. 60/850,692, filed on Oct. 10, 2006.

(51) Int. Cl. F27D 1/14

(52) U.S. Cl. 373/75

(57) ABSTRACT

An arrangement for protecting heat-absorptive elements in a high-temperature furnace includes a refractory member comprised of an interconnected metal structure embedded within the member and a tubular insert element capable of attaching the refractory member to the heat-absorptive element. The tubular insert has a hollow tubular body that is capable of sliding within a passageway through the embedded metal structure. The tubular insert has a rib or lip with an outer diameter larger than the passageway through the metal structure that engages the structure. When the other end of the tubular insert is connected to the heat-absorptive element, the rib holds the refractory member in place without a need to weld the tubular insert directly to the metal structure.

### CROSS REFERENCE TO RELATED APPLICATIONS

This application claims the benefit of U.S. Provisional Patent Application No. 60/850,692 filed Oct. 10, 2006, and entitled “Insert for Use in Securing Refractory Members to Heat-Absorptive Elements,” the contents of which are incorporated herein by reference.

### BACKGROUND OF THE INVENTION

1. Field of the Invention

This invention relates to furnace insulation systems, and more particularly, to means for securing refractory members to a heat-absorptive element in order to better protect the element from the extreme temperatures of the furnace.

2. Description of Related Art

Furnaces for heating metals often operate at extremely high temperatures. Within these furnaces are metal structures that provide structural support. In order to maintain the integrity of these support structures, the structures are insulated from the extreme heat by external refractory members and cooled internally with circulating fluid. These refractory members are connected to the metal support structures in a multitude of ways so as to withstand the high temperatures, thermal shock, vibrations, and other forces to which these support structures are subjected. Because these refractory members must be routinely replaced, ease of installation is also of importance.

One commonly known refractory member, disclosed in U.S. Pat. No. 4,528,672, comprises a refractory shape having an interconnected, reticulated metal mesh defined by a plurality of spirals embedded within the shape. This refractory member is connected to the heat-absorptive element through the use of an anchor pipe. The anchor pipe is a tubular insert that is inserted through the metal-mesh embedded in the refractory member and then welded to both the metal mesh and the heat-absorptive element. By securing the anchor pipe to both the metal mesh embedded within the refractory member and the heat-absorptive element, the refractory member remains connected to the heat-absorptive element.

However, the anchor pipe used in this refractory system suffers from several disadvantages. First, it takes considerable time and effort to weld the metal spirals to the anchor pipe to ensure that the anchor pipe remains secure within the refractory member. Second, the anchor pipe must always be secured to the heat-absorptive element by means of welding. Third, a washer must be welded into the anchor pipe to generate a lip which allows the refractory member(s) to be bolted to the heat-absorptive element.

It is therefore an object of the present invention to allow the operator the option of connecting the refractory member to the heat-absorptive element by either a bolting process or a welding process while also minimizing the steps necessary to secure a tubular insert within the refractory member.

### SUMMARY OF THE INVENTION

The present invention is directed to a protective refractory member for use in a high-temperature furnace. In one embodiment, the present invention comprises a refractory member, a reticulated metal structure embedded within the member and positioned so that there is at least one uninterrupted passageway through the metal structure and the member, a tubular insert located within the passageway wherein the tubular insert is comprised of a hollow tubular body with an outer diameter sized so that the tubular insert fits within the uninterrupted passageway, and two tubular insert ends wherein the outer diameter of the first end is larger than the outer diameter of the second end so that the second end fits within the uninterrupted passageway and the first end engages the metal structure.

In one variation, the inner diameter of the second end of the tubular insert is smaller than the inner diameter of the tubular body.

The refractory member of the present invention may additionally comprise a bolt, which is inserted through the tubular insert and secures the refractory member to a heat-absorptive element. Alternatively, the second end of the tubular insert can be connected to the heat-absorptive element by way of a weld.

In another variation, the invention may additionally comprise a bolt which is inserted through the tubular insert and connects the refractory member to another refractory member and thereby secures both refractory members to a heat-absorptive element within the furnace.

In another embodiment, the present invention comprises a first refractory member located immediately adjacent to and substantially covering one side of a heat-absorptive element and a second refractory member located immediately adjacent to and substantially covering the opposite side of the heat-absorptive element. In each of the refractory members, a reticulated metal structure is embedded therein and positioned so that there is at least one uninterrupted passageway through the structure and the refractory member. Additionally, in each of the refractory members, a tubular insert is located within the passageway, wherein the tubular insert is comprised of a hollow tubular body with an outer diameter smaller than the diameter of the uninterrupted passageway and two tubular insert ends wherein the outer diameter of the first end is larger than the diameter of said uninterrupted passageway. The first end of the insert engages the metal structure and the second end of the insert contacts the heat-absorptive element. The first and second refractory members are then secured to the heat-absorptive element. The heat-absorptive element can optionally be a water-cooled pipe.

This embodiment of the present invention may further comprise a bolt for securing the refractory members to the heat-absorptive element. Alternatively, at least one of the tubular inserts can be connected to the heat-absorptive element by way of a weld.

In another variation, the inner diameter of the second end of the tubular insert is smaller than the inner diameter of the tubular body of the insert.

### BRIEF DESCRIPTION OF THE DRAWINGS

FIG. 1 is a longitudinal sectional view of a tubular insert.

FIG. 2 is a plan view of the body of the tubular insert as it contacts an embedded metal structure.

FIG. 3 is a plan view of the lip of the tubular insert as it contacts and engages the metal structure.

FIG. 4 is a sectional view of a complete refractory system which illustrates the manner in which the tubular insert secures refractory members to a pair of heat-absorptive pipes by bolting the tubular insert directly to the heat-absorptive element.

FIG. 5 is a schematic view of the tubular insert as it engages the metal structure and contacts the heat-absorptive element which is protected by the refractory member.

FIG. 6 is a sectional view of a complete refractory system which illustrates the manner in which the tubular insert secures refractory members to a pair of heat-absorptive pipes by welding the tubular insert directly to the heat-absorptive element.

### DESCRIPTION OF THE PREFERRED EMBODIMENTS

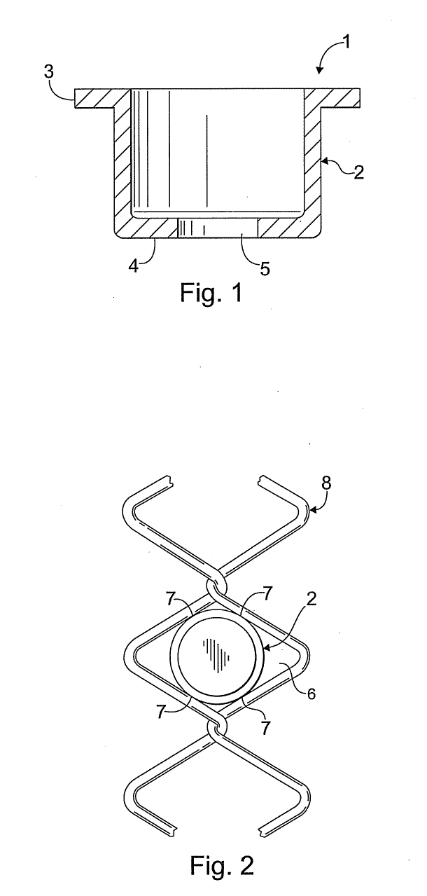

A tubular insert is shown in FIG. 1. The tubular insert 1 is a tubular member with an outer diameter that is consistent throughout its body 2 and includes two ends. At one end of the tubular insert, hereinafter known as the distal end, the outer diameter increases so as to form a lip, or rib, 3 around the outer circumference of the tubular insert 1. The inner diameter of the tubular insert remains constant from the distal end until the opposite end, hereinafter known as the basal end. At the basal end, the inner diameter narrows, creating a shelf, or inverted lip 4, around the inner circumference of the tubular insert 1. The radial extent of this shelf 4 is such that a flat washer can rest on the area between the inner diameter of the tubular insert body 2 and the inner diameter of the shelf 4. Optionally, this washer is a locking washer. Preferably, the difference between the inner diameter of the tubular insert body 2 and the inner diameter of the shelf 4 is between ¼″ and ½″, and ideally the difference in diameter is 11/32″. However, there remains an opening 5 in the basal end of the tubular insert 1 sufficiently large to allow the necessary angle for a weld rod so that a good structural weld can be obtained between the basal end of the tubular insert 1 and the surface of a heat-absorptive element to be protected. The opening 5 in the basal end of the tubular insert 1 is preferably between ½″ and 1″ in diameter and ideally is 25/32″ in diameter. The tubular insert 1 can be made out of any weldable metal, such as carbon steel, and is preferably constructed of stainless steel pipe, such as 304 stainless. The length of the tubular insert 1 varies depending on the density of the refractory member, with a longer tubular insert being feasible in a less dense, better insulated member. Generally, the tubular insert will be on the order of ½ the thickness of the refractory member, but ¾″ tubular inserts can also be used with 2″ thick refractory shapes.

The tubular insert of the instant invention is to be used with a refractory member similar to that described in U.S. Pat. No. 4,528,672, which is expressly incorporated herein by reference. Specifically, the tubular insert of the current invention is to be used with a refractory member having a reticulated metal structure, optionally defined by a plurality of spirals, embedded within. The metal structure may, for example, be in the form of a chain mesh, similar to a link fence, or in the form of a plurality of chains.

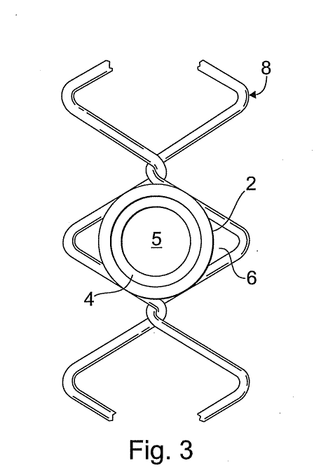

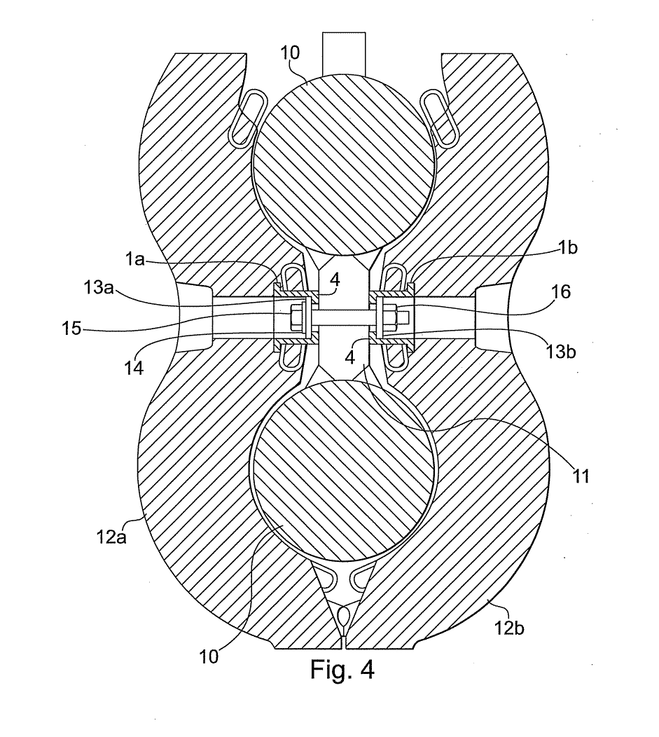

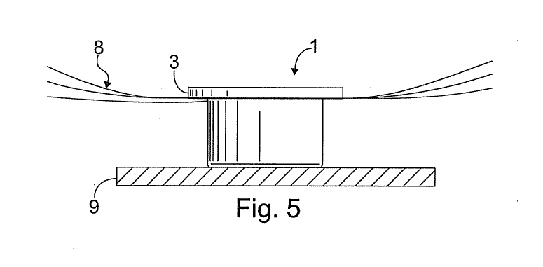

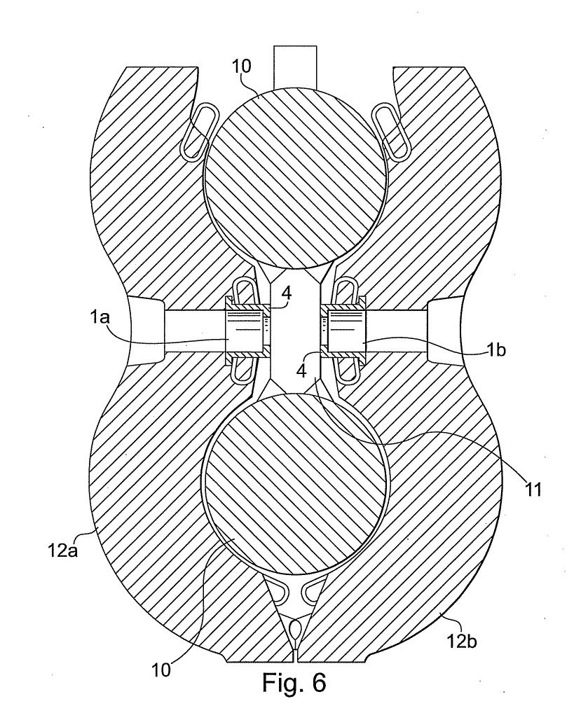

When using the tubular insert 1 to secure the refractory member to the heat-absorption element, the tubular insert 1 is positioned within a passageway 6 through the metal structure 8. The outer diameter of the tubular insert body 2 is specially sized so that it fits securely in this passageway 6 and remains in contact with the metal structure 8 at a plurality of locations 7, as seen in FIG. 2. The lip 3 located at the distal end of the tubular insert 1 has an outer diameter that is larger than the passageway 6 so that the lip 3 engages the metal structure 8, thus preventing the tubular insert from passing completely through the passageway 6, as seen in FIG. 3. As illustrated in FIG. 5, when the tubular insert 1 is forced into contact with the heat-absorptive element 9, the lip 3 may collect and gather the metal structure 8, thus increasing the contacts between the tubular insert 1 and the metal structure 8. This connection between the tubular insert 1 and the metal structure 8 serves both to ensure that the tubular insert 1 remains securely embedded within the refractory member and to dissipate heat from the tubular insert 1 into the refractory member, preventing the rapid deterioration of the tubular insert 1.

A typical application of a bolt to connect the tubular insert to the heat-absorptive element is shown in FIG. 4. Two parallel water cooled metal pipes 10 are connected with a metal web 11. The metal web 11 has a hole in it sufficient in size to allow, for example, a bolt, screw, nail or other connection device to pass through. A refractory member 12a and 12b is positioned on either side of the tandem pipes 10. A tubular insert 1a and 1b is inserted into each of the refractory members 12a and 12b until the basal end comes into contact with the metal web 11. Alternatively, the tubular insert 1a and 1b can be integrated into the refractory member 12a and 12b, such as by a weld, adhesive, or snap-fit arrangement, for example, before the refractory member 12a and 12b is positioned adjacent the heat-absorptive element. The tubular inserts 1a and 1b are positioned so that they are in line with the hole in the web 11 allowing an open channel to exist. In one embodiment, a ⅜″ by 1″ (outer diameter) flat washer 13a and 13b is positioned on the internal washer ledge 4 of each of the tubular inserts 1a and 1b. On the flat washer 13a is placed a ⅜″ locking washer 14 and a ⅜ screw 15 or bolt is inserted through the tubular insert 1a containing the lock washer 14, through the hole in the web 11, and eventually through the other flat washer 13b. A ⅜″ hex nut 16 is tightened onto the screw 15 so that the two tubular inserts 1a and 1b are each secured against the web 11 of the metal pipes 10. Because the tubular insert 1a and 1b is also securely retained within the metal structure 8 of the refractory members 12a and 12b, the refractory members 12a and 12b are securely connected to the metal pipes 10, protecting them from the surrounding environment. Other securing arrangements using the tubular inserts 1a and 1b, in addition to the bolt and nut arrangement, will be appreciated to those skilled in the art. For example, a wing nut or expansion nut could be used in securing the tubular inserts 1a and 1b to the heat-absorptive element.

A typical application of the use of a weld to connect the tubular insert to the heat-absorptive element is shown in FIG. 6. Two parallel water cooled metal pipes 10 are connected with a metal web 11. A refractory member 12a and 12b is positioned on either side of the metal pipes 10 and a tubular insert 1a and 1b is inserted into each of the refractory members 12a and 12b until the tubular insert 1a and 1b comes into contact with the metal web 11. A weld rod is inserted into the opening in the tubular insert 5a and 5b, as will be apparent to those skilled in the art. The basal edge of the tubular insert, which is in contact with the metal web 11, is welded to the surface of the web 11. This weld 17 may go around the inside perimeter of the tubular insert 1a and 1b or it may be a fillet weld or a pair of such welds. Because the tubular insert 1a and 1b is also securely retained within the metal structure 8 of the refractory members 12a and 12b, the refractory members 12a and 12b are securely connected to the metal pipes 10, protecting them from the surrounding environment.

The tubular insert provides many advantages over the prior art. For one, the tubular insert reduces labor and associated costs required to manufacture the refractory member. Additionally, the tubular insert reduces inventory since a single refractory shape can be attached to a heat-absorptive element in several different ways, such as through a bolting or welding process. Other advantages of the invention over the prior art will be apparent to those skilled in the art.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. A device for protecting heat-absorptive elements in a high-temperature furnace, comprising:
a refractory member;
a reticulated metal structure embedded within the member and positioned so that there is at least one uninterrupted passageway through said metal structure and said member;
a tubular insert located within said passageway, wherein said tubular insert is comprised of a hollow tubular body with an outer diameter sized so that said tubular insert fits within said uninterrupted passageway; and
two tubular insert ends wherein the outer diameter of a first end is larger than the outer diameter of a second end so that the second end fits within said uninterrupted passageway and the first end engages said metal structure.

2. The device of claim 1, wherein the inner diameter of the second end of said tubular insert is smaller than the inner diameter of the tubular body.

3. The device of claim 2, further comprising a washer placed within said hollow tubular body adjacent the second end of said tubular insert.

4. The device of claim 3, wherein the washer is a locking washer.

5. The device of claim 2, further comprising a bolt inserted through said tubular insert, wherein said bolt secures said refractory member to a heat-absorptive element within said furnace.

6. The device of claim 2, wherein the difference between the inner diameter of said second end of said tubular insert and the inner diameter of said tubular body is between ¼″ and ½″.

7. The device of claim 2, wherein the opening in said second end of said tubular insert is between ½″ and 1″ in diameter.

8. The device of claim 1, wherein the tubular insert is comprised of stainless steel.

9. The device of claim 1, wherein the length of the tubular insert is equal to at least ½ the thickness of the refractory member.

10. The device of claim 1, wherein the second end of said tubular insert is connected to the heat-absorptive element by way of a weld.

11. The device of claim 2, further comprising a bolt inserted through said tubular insert, wherein said bolt connects the refractory member to a second refractory member and thereby secures both refractory members to the heat-absorptive element within said furnace.

12. An arrangement for protecting heat-absorptive elements in a high-temperature furnace, comprising:
a first refractory member located adjacent to and substantially covering one side of said heat-absorptive element;
a second refractory member located adjacent to and substantially covering the opposite side of said heat-absorptive element;
in each of said first and second refractory members, a reticulated metal structure embedded therein and positioned so that there is at least one uninterrupted passageway through said structure and said refractory member; and
in each of said first and second refractory members, a tubular insert located within said passageway, wherein said tubular insert is comprised of a hollow tubular body with an outer diameter smaller than the diameter of said uninterrupted passageway and two tubular insert ends wherein the outer diameter of the first end is larger than the diameter of said uninterrupted passageway, said first end engaging said metal structure; and
securing means engaging said tubular inserts for mounting said refractory members to said heat-absorptive element.

13. The arrangement of claim 12, further comprising a bolt for securing said first refractory member and said second refractory member to said heat-absorptive element.

14. The arrangement of claim 12, wherein at least one of said tubular inserts is connected to said heat-absorptive element by way of a weld.

15. The arrangement of claim 12, wherein the inner diameter of the second end of said tubular insert is smaller than the inner diameter of the tubular body.

16. The arrangement of claim 12, wherein the opening in said second end of said tubular insert is between ½″ and 1″ in diameter.

17. The arrangement of claim 12, wherein the heat-absorptive element is a water-cooled pipe.

18. A method of protecting a heat-absorptive element, comprising the steps of:
positioning a first refractory member adjacent to said heat-absorptive element, said first refractory member comprising a reticulated metal structure embedded therein and positioned so that there is at least one uninterrupted passageway through said structure and said first refractory member;
positioning a second refractory member adjacent to the opposite side of said heat-absorptive element, said second refractory member comprising a reticulated metal structure embedded therein and positioned so that there is at least one uninterrupted passageway through said structure and said second refractory member;
inserting a tubular insert within said passageway of each of said first refractory member and said second refractory member;
engaging a first end of each tubular insert with its respective metal structure; and
securing said tubular inserts in place, thereby affixing each of said first and second refractory members with respect to said heat-absorptive element.

19. The method of claim 18, wherein said tubular inserts are secured in place by a weld.

20. The method of claim 18, wherein said tubular inserts are secured in place by a bolt.
